(19) United States
(12) Patent Application Publication
(10) Pub. No.: US 2015/0099627 A1
(43) Pub. Date: Apr. 9, 2015

(54) Co-Formulations of Bifenthrin with Encapsulated Crop Protection Agents For Use with Liquid Fertilizers

(71) Applicant: FMC Corporation, Philadelphia, PA (US)

(72) Inventors: Timothy M. Martin, Ringoes, NJ (US); William Scherzinger, Jackson, NJ (US); Margarita Giavis, Toms River, NJ (US)

(73) Assignee: FMC Corporation, Philadelphia, PA (US)

(21) Appl. No.: 14/217,534

(22) Filed: Mar. 18, 2014

Related U.S. Application Data
(60) Provisional application No. 61/887,104, filed on Oct. 4, 2013.

(51) Int. Cl. A01N 57/16; A01N 25/34; C05G 3/02; A01N 53/00

(52) U.S. Cl. CPC A01N 57/16; A01N 53/00; A01N 25/34; C05G 3/02
USPC 504/101; 514/531; 514/520; 514/89; 424/408

(57) ABSTRACT

Insecticidal compositions suitable for use in preparation of insecticidal liquid fertilizers are disclosed, the compositions comprising bifenthrin, an encapsulated crop protection agent, a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester.

### CROSS-REFERENCE TO RELATED APPLICATIONS

This application claims the benefit under 35 U.S.C. §119(e) of U.S. Provisional Application Ser. No. 61/887,104, filed Oct. 4, 2013, the disclosure of which is incorporated herein by reference in its entirety.

### FIELD OF THE INVENTION

The present invention relates to the field of agrochemical compositions and formulations. In particular, the invention provides an insecticidal composition comprising unencapsulated bifenthrin in combination with an encapsulated crop protection agent, where the composition is suitable for use in the preparation of insecticidal liquid fertilizers.

### BACKGROUND OF THE INVENTION

To enable the efficient elimination or control of unwanted insects in combination with providing nutrients for plants to combat adverse environmental conditions (such as heat, drought, physical contact with animals, etc.) it is desirable to formulate an effective chemical insecticide for use in preparation of insecticidal liquid fertilizers. Formulations of insecticides combined with fertilizers are desirable in agricultural and related endeavors due to the multiple benefits conveyed by just one application in a single piece of equipment. One application of such a combination or formulation provides nutrients for the plant growth, while eliminating or controlling unwanted insects that can also affect the health and vitality of the desirable plants.

Mixtures containing insecticide compositions and liquid fertilizers have been practiced in the art, but problems with the physical stability of such mixtures have caused application and efficacy issues. When a traditional insecticidal composition is combined with a liquid fertilizer, the combined components (surfactants, viscosity modifiers, wetting agents) of both can cause accelerated physical degradation (phase separation) of the mixture. This physical degradation can occur in the mix tanks prior to application on the plants. Often this problem goes unnoticed and results in inconsistent application of both the fertilizer and insecticide, yielding inadequate efficacy of both.

### SUMMARY OF THE INVENTION

In one aspect, the present invention is directed to an insecticidal composition comprising a) unencapsulated bifenthrin; b) at least one encapsulated crop protection agent; c) a hydrated aluminum-magnesium silicate; and d) at least one dispersant selected from the group consisting of a sucrose ester, a lignosulfonate, an alkylpolyglycoside, a naphthalenesulfonic acid formaldehyde condensate and a phosphate ester. Preferably the insecticidal composition comprises a) about 1% to about 35% of bifenthrin; b) about 1% to about 30% of at least one encapsulated insecticide; c) about 1% to about 20% of hydrated aluminum-magnesium silicate; and d) about 0.2% to about 20% of at least one dispersant selected from the group consisting of a sucrose ester, a lignosulfonate, an alkylpolyglycoside, a naphthalenesulfonic acid formaldehyde condensate and a phosphate ester; where all % are % by weight based upon the total weight of all components in the composition.

In one embodiment, the encapsulated crop protection agent is a low-melting compound, having a melting point <50° C. In another embodiment, the encapsulated crop protection agent is a high-melting compound, having a melting point of about 50° C. or greater.

Another embodiment of the invention is directed to the above composition where encapsulation of insecticide component b) comprises interfacial polymerization in the presence of the crop protection agent.

In one embodiment of the composition, the hydrated aluminum-magnesium silicate is selected from the group consisting of montmorillonite and attapulgite. In certain embodiments of the composition the phosphate ester is selected from the group consisting of a nonyl phenol phosphate ester and a tridecyl alcohol ethoxylated phosphate potassium salt.

Another aspect of the invention is directed to an insecticidal liquid fertilizer composition where the above insecticidal composition further comprises a liquid fertilizer. Preferably the liquid fertilizer is aqueous-based. Preferably the liquid fertilizer is present in a concentration of about 95.0% by weight to about 99.99% by weight based on the total weight of all components in the composition. Preferably, the other components of the insecticidal liquid fertilizer composition include unencapsulated bifenthrin in about 0.75% to about 1.25%, the encapsulated insecticide in about 0.75% to about 1.25%, the hydrated aluminum-magnesium silicate in about 0.05% to about 1.0%, and the dispersant in about 0.1% to about 0.75% by weight based on the total weight of all components in the composition.

The above compositions can further comprise at least one of an anti-freeze agent, an anti-foam agent and a biocide.

### DETAILED DESCRIPTION OF THE INVENTION

In accordance with the present invention, it has now been found that a new insecticidal composition significantly improves physical stability when used to prepare an insecticidal liquid fertilizer. Specifically, the present invention is directed to an insecticidal composition that includes unencapsulated bifenthrin, an additional encapsulated crop protection agent, a hydrated aluminum-magnesium silicate, and at least one dispersant selected from the group consisting of a sucrose ester, a lignosulfonate, an alkylpolyglycoside, a naphthalenesulfonic acid formaldehyde condensate and a phosphate ester.

A particularly difficult combination to formulate is a liquid-fertilizer-ready combination of a high-melting solid active ingredient, for example bifenthrin, with a low-melting solid active ingredient, for example another insecticide such as cypermethrin, zeta-cypermethrin or chlorpyrifos. As disclosed herein, encapsulation of the low-melting solid active ingredient protects the formulation from degradation during preparation, storage and/or application conditions where the melting point of the low-melting active ingredient might be approached or exceeded.

For other reasons, even those active ingredients which are higher melting might benefit from encapsulation in such a formulation. Therefore, in another embodiment, the encapsulated crop protection agent is a high-melting compound.

In one embodiment, the encapsulated crop protection agent is an insecticide and is one or more selected from Group A, consisting of:

A1) the class of carbamates consisting of aldicarb, alanycarb, benfuracarb, carbaryl, carbofuran, carbosulfan, methiocarb, methomyl, oxamyl, pirimicarb, propoxur and thiodicarb; or

A2) the class of organophosphates consisting of acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlor-vinphos, triazophos and trichlorfon;

A3) the class of cyclodiene organochlorine compounds such as endosulfan;

A4) the class of fiproles consisting of ethiprole, fipronil, pyrafluprole and pyriprole;

A5) the class of neonicotinoids consisting of acetamiprid, chlothianidin, dinotefuran, imidacloprid, nitenpyram, thiacloprid and thiamethoxam;

A6) the class of spinosyns such as spinosad and spinetoram;

A7) chloride channel activators from the class of mectins consisting of abamectin, emamectin benzoate, ivermectin, lepimectin and milbemectin;

A8) juvenile hormone mimics such as hydroprene, kinoprene, methoprene, fenoxycarb and pyriproxyfen;

A9) selective homopteran feeding blockers such as pymetrozine, flonicamid and pyrifluquinazon;

A10) mite growth inhibitors such as clofentezine, hexythiazox and etoxazole;

A11) inhibitors of mitochondrial ATP synthase such as diafenthiuron, fenbutatin oxide and propargite; uncouplers of oxidative phosphorylation such as chlorfenapyr;

A12) nicotinic acetylcholine receptor channel blockers such as bensultap, cartap hydrochloride, thiocyclam and thiosultap sodium;

A13) inhibitors of the chitin biosynthesis type 0 from the benzoylurea class consisting of bistrifluron, diflubenzuron, flufenoxuron, hexaflumuron, lufenuron, no-valuron and teflubenzuron;

A14) inhibitors of the chitin biosynthesis type 1 such as buprofezin;

A15) moulting disruptors such as cyromazine;

A16) ecdyson receptor agonists such as methoxyfenozide, tebufenozide, halofenozide and chromafenozide;

A17) octopamin receptor agonists such as amitraz;

A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim;

A19) voltage-dependent sodium channel blockers such as indoxacarb and metaflumizone;

A20) inhibitors of the lipid synthesis such as spirodiclofen, spiromesifen and spirotetramat;

A21) ryanodine receptor-modulators from the class of diamides consisting of flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chloranthraniliprole and cy-anthraniliprole;

A22) compounds of unknown or uncertain mode of action such as azadirachtin, amidoflumet, bifenazate, fluensulfone, piperonyl butoxide, pyridalyl, sulfoxaflor;

A23) sodium channel modulators from the class of pyrethroids consisting of acrinathrin, allethrin, bifenthrin, cyfluthrin, lambda-cyhalothrin, cyper-methrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

In one embodiment, the crop protection agent is an insecticide, which is one of more selected from abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin. In one specific embodiment the encapsulated insecticide is zeta-cypermethrin. In another specific embodiment the encapsulated insecticide is chlorpyrifos.

In one embodiment, the encapsulated crop protection agent is a fungicide and is one or more selected from Group B consisting of:

B1) azoles selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thia-bendazole, fuberidazole, ethaboxam, etridiazole and hymexazole, azaconazole, diniconazole-M, oxpoconazol, paclobutrazol, uniconazol, 1-(4-chloro-phenyl)-2-([1,2,4]triazol-1-yl)-cycloheptanol and imazalilsulfphate;

B2) strobilurins selected from the group consisting of azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate and methyl 2-(ortho-(2,5-dimethylphenyloxymethylene)-phenyl)-3-methoxyacrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclopropanecarboximidoyl-ulfanylmethyl)-phenyl)-acrylic acid methyl ester;

B3) carboxamides selected from the group consisting of carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, 3,4-dichloro-N-(2-cyanophenyl)isothiazole-5-carboxamide, dimethomorph, flumorph, flumetover, fluopicolide (picobenzamid), zoxamide, carpropamid, diclocymet, mandipropamid, N-(2-(4-[3-(4-chlorophenyl)prop-2-ynyloxy]-3-methoxyphenyl)ethyl)-2-methanesulfonyl-amino-3-methylbutyramide, N-(2-(4-[3-(4-chloro-phenyl)prop-2-ynyloxy]-3-methoxy-phenyl)ethyl)-2-ethanesulfonylamino-3-methylbutyramide, methyl 3-(4-chlorophenyl)-3-(2-isopropoxycarbonyl-amino-3-methyl-butyrylamino)propionate, N-(4′-bromobiphenyl-2-yl)-4-difluoromethyl̂-methylthiazole-δ-carboxamide, N-(4′-trifluoromethyl-biphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3,4′-dichloro-4-fluorobiphenyl-2-yl)-3-difluoro-methyl-1-methyl-pyrazole-4-carboxamide, N-(3′,4′-dichloro-5-fluorobiphenyl-2-yl)-3-difluoromethyl-1-methylpyrazole-4-carboxamide, N-(2-cyano-phenyl)-3,4-dichloroisothiazole-5-carboxamide, 2-amino-4-methyl-thiazole-5-carboxanilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carboxamide, N-(4′-chloro-3′,5-difluoro-biphenyl-2-yl)-3-trifluoromethyl-1-methyl-1H-pyrazole-4-carboxamide, N-(3′,4′-dichloro-5-fluoro-biphenyl-2-yl)-3-trifluoromethyl-1-methyl-1H-pyrazole-4-carboxamide, N-(3′,5-difluoro-4′-methyl-biphenyl-2-yl)-3-difluoromethyl-1-methyl-1H-pyrazole-4-carboxamide, N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoro-methyl-1-methyl-1H-pyrazole-4-carboxamide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl)cyclopropanecarboxamide, 2-iodo-N-phenyl-benzamide, N-(2-bicyclo-propyl-2-yl-phenyl)-3-difluormethyl-1-methylpyrazol-4-ylcarboxamide, N-(3′,4′,5′-trifluorobiphenyl-2-yl)-1,3-dimethylpyrazol-4-ylcarboxamide, N-(3′,4′,5′-trifluorobiphenyl-2-yl)-1,3-dimethyl-5-fluoropyrazol-4-yl-carboxamide, N-(3′,4′,5′-trifluorobiphenyl-2-yl)-5-chloro-1,3-dimethyl-pyrazol-4-ylcarboxamide, N-(3′,4′,5′-trifluorobiphenyl-2-yl)-3-fluoromethyl-1-methylpyrazol-4-ylcarboxamide, N-(3′,4′,5′-trifluorobiphenyl-2-yl)-3-(chlorofluoromethyl)-1-methylpyrazol-4-ylcarboxamide,N-(3′,4′,5′-trifluorobiphenyl-2-yl)-3-difluoromethyl-1-methylpyrazol-4-ylcarboxamide, N-(3′,4′,5′-trifluorobiphenyl-2-yl)-3-difluoromethyl-5-fluoro-1-methylpyrazol-4-ylcarboxamide, N-(3′,4′,5′-trifluorobiphenyl-2-yl)-5-chloro-3-difluoromethyl-1-methylpyrazol-4-ylcarboxamide, N-(3′,4′,5′-trifluorobiphenyl-2-yl)-3-(chlorodifluoromethyl)-1-methylpyrazol-4-ylcarboxamide, N-(3′,4′,5′-trifluorobiphenyl-2-yl)-1-methyl-3-trifluoromethylpyrazol-4-ylcarboxamide, N-(3′,4′,5′-trifluorobiphenyl-2-yl)-5-fluoro-1-methyl-3-trifluoromethylpyrazol-4-ylcarboxamide, N-(3′,4′,5′-trifluorobiphenyl-2-yl)-5-chloro-1-methyl-3-trifluoromethylpyrazol-4-ylcarboxamide, N-(2′,4′,5′-trifluorobiphenyl-2-yl)-1,3-dimethylpyrazol-4-ylcarboxamide, N-(2′,4′,5′-trifluorobiphenyl-2-yl)-1,3-dimethyl-5-fluoropyrazol-4-ylcarboxamide, N-(2′,4′,5′-trifluorobiphenyl-2-yl)-5-chloro-1,3-dimethylpyrazol-4-ylcarboxamide, N-(2′,4′,5′-trifluorobiphenyl-2-yl)-3-fluoromethyl-1-methylpyrazol-4-ylcarboxamide, N-(2′,4′,5′-trifluorobiphenyl-2-yl)-3-(chlorofluoromethyl)-1-methylpyrazol-4-ylcarboxamide,N-(2′,4′,5′-trifluorobiphenyl-2-yl)-3-difluoromethyl-1-methylpyrazol-4-ylcarboxamide, N-(2′,4′,5′-trifluorobiphenyl-2-yl)-3-difluoromethyl-5-fluoro-1-methylpyrazol-4-ylcarboxamide, N-(2′,4′,5′-trifluorobiphenyl-2-yl)-5-chloro-3-difluoromethyl-1-methylpyrazol-4-ylcarboxamide, N-(2′,4′,5′-trifluorobiphenyl-2-yl)-3-(chlorodifluoromethyl)-1-methylpyrazol-4-ylcarboxamide, N-(2′,4′,5′-trifluorobiphenyl-2-yl)-1-methyl-3-trifluoromethylpyrazol-4-ylcarboxamide, N-(2′,4′,5′-trifluorobiphenyl-2-yl)-5-fluoro-1-methyl-3-trifluoromethylpyrazol-4-ylcarboxamide, N-(2′,4′,5′-trifluorobiphenyl-2-yl)-5-chloro-1-methyl-3-trifluoromethylpyrazol-4-ylcarboxamide, N-(3′,4′-dichloro-3-fluorobiphenyl-2-yl)-1-methyl-3-trifluoromethyl-1H-pyrazole-4-carboxamide, N-(3′,4′-dichloro-3-fluorobiphenyl-2-yl)-1-methyl-3-difluoromethyl-1H-pyrazole-4-carboxamide, N-(3′,4′-difluoro-3-fluorobiphenyl-2-yl)-1-methyl-3-trifluoromethyl-1H-pyrazole-4-carboxamide, N-(3′,4′-difluoro-3-fluorobiphenyl-2-yl)-1-methyl-S-difluoromethyl-1H-pyrazole-4-carboxamide, N-(3′-chloro-4′-fluoro-3-fluorobiphenyl-2-yl)-1-methyl-3-difluoromethyl-1H-pyrazole-4-carboxamide, N-(3′,4′-dichloro-4-fluorobiphenyl-2-yl)-1-methyl-3-trifluoromethyl-1H-pyrazole-4-carboxamide, N-(3′,4′-difluoro-4-fluorobiphenyl-2-yl)-1-methyl-S-trifluoromethyl-1H-pyrazole-4-carboxamide, N-(3′,4′-dichloro-4-fluorobiphenyl-2-yl)-1-methyl-3-difluoromethyl-1H-pyrazole-4-carboxamide, N-(3′,4′-difluoro-4-fluorobiphenyl-2-yl)-1-methyl-3-difluoromethyl-1H-pyrazole-4-carboxamide, N-(3′-chloro-4′-fluoro-4-fluorobiphenyl-2-yl)-1-methyl-S-difluoromethyl-1H-pyrazole-4-carboxamide, N-(3′,4′-dichloro-5-fluorobiphenyl-2-yl)-1-methyl-3-trifluoromethyl-1H-pyrazole-4-carboxamide, N-(3′,4′-difluoro-5-fluorobiphenyl-2-yl)-1-methyl-3-trifluoromethyl-1H-pyrazole-4-carboxamide, N-(3′,4′-dichloro-5-fluorobiphenyl-2-yl)-1-methyl-S-difluoromethyl-1H-pyrazole-carboxamide, N-(3′,4′-difluoro-5-fluorobiphenyl-2-yl)-1-methyl-3-difluoromethyl-1H-pyrazole-4-carboxamide, N-(3′,4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-fluorobiphenyl-2-yl)-1-methyl-3-trifluoromethyl-1H-pyrazole-4-carboxamide,N-(4′-chloro-5-fluorobiphenyl-2-yl)-1-methyl-3-trifluoromethyl-1H-pyrazole-4-carboxamide, N-(4′-methyl-5-fluorobiphenyl-2-yl)-1-methyl-3-trifluoromethyl-1H-pyrazole-4-carboxamide, N-(4′-fluoro-5-fluorobiphenyl-2-yl)-1,3-dimethyl-1H-pyrazole-4-carboxamide, N-(4′-chloro-5-fluorobiphenyl-2-yl)-1,3-dimethyl-1H-pyrazole-4-carboxamide, N-(4′-methyl-5-fluorobiphenyl-2-yl)-1,3-dimethyl-1H-pyrazole-4-carboxamide, N-(4′-fluoro-6-fluorobiphenyl-2-yl)-1-methyl-3-trifluoromethyl-1H-pyrazole-4-carboxamide, N-(4′-chloro-6-fluorobiphenyl-2-yl)-1-methyl-3-trifluoromethyl-1H-pyrazole-4-carboxamide, N-[2-(1,1,2,3,3,3-hexafluoropropoxy)-phenyl]-3-difluoromethyl-1-methyl-1H-pyrazole-4-carboxamide, N-[4′-(trifluoromethylthio)-biphenyl-2-yl]-3-difluoromethyl-1-methyl-1H-pyrazole-4-carboxamide and N-[4′-(trifluoromethylthio)-biphenyl-2-yl]-1-methyl-3-trifluoromethyl-1-methyl-1H-pyrazole-4-carboxamide;

B4) heterocyclic compounds selected from the group consisting of fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, proben-azole, 5-chloro-7-(4-methyl-piperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen, N,N-dimethyl-3-(3-bromo-6-fluoro-2-methylindole-1-sulfonyl)-[1,2,4]triazole-1-sulfonamide, 5-ethyl-6-octyl-[1,2,4]triazolo[1,5-a]pyrimidin-2,7-diamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro pyridin-2-yl)-methyl)-2,4-dichloro-nicotinamide, diflumetorim, nitrapyrin, dodemorphacetate, fluoroimid, blasticidin-S, chinomethionat, debacarb, difenzoquat, difenzoquat-methylsulphat, oxolinic acid and piperalin;

B5) carbamates selected from the group consisting of mancozeb, maneb, metam, methasulphocarb, metiram, ferbam, propineb, thiram, zineb, ziram, diethofencarb, iprovalicarb, benthiavalicarb, propamocarb, propamocarb hydrochlorid, 4-fluorophenyl N-(1-(1-(4-cyanophenyl)-ethanesulfonyl)but-2-yl)carbamate, methyl 3-(4-chloro-phenyl)-3-(2-isopropoxycarbonylamino-3-methyl-butyrylamino)propanoate;

B6) other fungicides selected from the group consisting of guanidine, dodine, dodine free base, iminoctadine, guazatine, antibiotics: kasugamycin, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts, organophosphorus compounds: edifenphos, iprobenfos, fosetyl, fosetyl-aluminum, phosphorous acid and its salts, pyrazophos, tolclofos-methyl, organochlorine compounds: dichlofluanid, flusulfamide, hexachloro-benzene, phthalide, pencycuron, quintozene, thiophanate-methyl, tolylfluanid, others: cyflufenamid, cymoxanil, dimethirimol, ethirimol, furalaxyl, metrafenone and spiroxamine, guazatine-acetate, iminoc-tadine-triacetate, iminoctadine-tris(albesilate), kasugamycin hydrochlorid-hydrat, dichlorophen, pentachlorophenol and its salts, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxincopper, prohexadione calcium, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methylformamidine and N′-(5-difluormethyl-2-methyl-4-(3-trimethylsilanyl-propoxy)-phenyl)-N-ethyl-N-methyl formamidine.

In one embodiment, the crop protection agent is a fungicide, which is one or more selected from bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, pefurazoate, imazalil, triflumizole, cyazofamid, benomyl, carbendazim, thiabendazole, fuberidazole, ethaboxam, etridiazole and hymexazole, azaconazole, diniconazole-M, oxpoconazol, paclobutrazol, uniconazol, imazalilsulfphate, azoxystrobin, dimoxystrobin, fluoxastrobin, kresoxim-methyl, orysastrobin, picoxystrobin, pyraclostrobin, trifloxystrobin, enestroburin, carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, dimethomorph, flumorph, fluopicolide (picobenzamid), zoxamide, carpropamid, diclocymet, mandipropamid, bixafen, fluazinam, cyprodinil, fenarimol, ferimzone, mepanipyrim, nuarimol, pyrimethanil, fenpiclonil, fludioxonil, aldimorph, dodemorph, fenpropimorph, iprodione, procymidone, vinclozolin, famoxadone, fenamidone, probenazole, acibenzolar-S-methyl, captafol, captan, dazomet, folpet, fenoxanil, quinoxyfen, nitrapyrin, fluoroimid, blasticidin-S, chinomethionat, difenzoquat-methylsulphate, oxolinic acid, mancozeb, maneb, methasulphocarb, metiram, ferbam, propineb, thiram, zineb, ziram, diethofencarb, iprovalicarb, benthiavalicarb, propamocarb hydrochloride, guanidine, dodine, kasugamycin, validamycin A, binapacryl, dinobuton, dithianon, isoprothiolane, fosetyl-aluminum, pyrazophos, tolclofos-methyl, dichlofluanid, flusulfamide, hexachlorobenzene, phthalide, pencycuron, quintozene, thiophanate-methyl, tolylfluanid, cyflufenamid, cymoxanil, ethirimol, furalaxyl, metrafenone, iminoctadine-triacetate, iminoctadine-tris(albesilate), kasugamycin hydrochloride-hydrate, dichlorophen, pentachlorophenol and its salts, dicloran, nitrothal-isopropyl, tecnazen, biphenyl, bronopol, diphenylamine, mildiomycin, oxine-copper and prohexadione calcium.

As used in this specification and unless otherwise indicated the term “crop protection agent” refers to a molecule or combination of molecules which express biological activity as a pesticide, arthropodicide, insecticide, acaricide, nematocide, fungicide, herbicide, plant growth regulator or a combination of two or more of these biological activities. As used in this specification and unless otherwise indicated the term “insecticide” refers to a molecule or combination of molecules that repels, retards, or kills insects, and can be used for crop protection, edifice protection, turf protection, or protection of a person. The term “liquid fertilizer” refers to a fertilizer in a fluid or liquid form containing various ratios of nitrogen, phosphorous and potassium (for example, but not limited to, 10% nitrogen, 34% phosphorous and 0% potassium) and micronutrients, commonly known as starter fertilizers that are high in phosphorus and promote rapid and vigorous root growth. Liquid fertilizers are commonly aqueous-based. As used herein, the term “aqueous-based” indicates that the predominant solvent or vehicle is water. The term “ambient temperature” as utilized herein shall mean any suitable temperature found in a laboratory or other working environment, and is generally not below about 15° C., nor above about 30° C.

The modifier “about” is used herein to indicate that certain preferred operating ranges, such as ranges for molar ratios for reactants, material amounts, and temperature, are not fixedly determined. The meaning will often be apparent to one of ordinary skill. For example, a recitation of a temperature range of about 120° C. to about 135° C. in reference to, for example, an organic chemical reaction would be interpreted to include other like temperatures that can be expected to favor a useful reaction rate for the reaction, such as 105° C. or 150° C. Where guidance from the experience of those of ordinary skill is lacking, guidance from the context is lacking, and where a more specific rule is not recited below, the “about” range shall be not more than 10% of the absolute value of an end point or 10% of the range recited, whichever is less.

Besides bifenthrin, other high-melting pyrethroids can be employed in the present invention. The preferred high melting pyrethroids include, without limitation, beta-cypermethrin, cypermethrin, deltamethrin, gamma-cyhalothrin, tralomethrin, cyfluthrin, beta-cyfluthrin and tralomethrin, more particularly, the pyrethroid is bifenthrin. For the purposes of the present invention, a “high melting” compound has a melting point of about 50° C. or greater, and a “low melting” compound has a melting point of <50° C. Bifenthrin, or the high-melting pyrethroid is preferably present in a concentration of from about 1.0% by weight to about 25% by weight, more particularly, from about 15% by weight to about 25% by weight based upon the total weight of all components in the composition. In one embodiment, the high-melting pyrethroid is bifenthrin. Preferably, the high-melting pyrethroid is unencapsulated. In another embodiment, the high-melting pyrethroid is unencapsulated bifenthrin.

In one embodiment, the encapsulated crop protection agent is an insecticide or fungicide, present in an insecticidally or fungicidally effective amount. Preferred insecticides are selected from the group consisting of abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin. Preferred fungicides are selected from the group consisting of bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, pefurazoate, imazalil, triflumizole, cyazofamid, benomyl, carbendazim, thiabendazole, fuberidazole, ethaboxam, etridiazole and hymexazole, azaconazole, diniconazole-M, oxpoconazol, paclobutrazol, uniconazol, imazalilsulfphate, azoxystrobin, dimoxystrobin, fluoxastrobin, kresoxim-methyl, orysastrobin, picoxystrobin, pyraclostrobin, trifloxystrobin, enestroburin, carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, dimethomorph, flumorph, fluopicolide (picobenzamid), zoxamide, carpropamid, diclocymet, mandipropamid, bixafen, fluazinam, cyprodinil, fenarimol, ferimzone, mepanipyrim, nuarimol, pyrimethanil, fenpiclonil, fludioxonil, aldimorph, dodemorph, fenpropimorph, iprodione, procymidone, vinclozolin, famoxadone, fenamidone, probenazole, acibenzolar-S-methyl, captafol, captan, dazomet, folpet, fenoxanil, quinoxyfen, nitrapyrin, fluoroimid, blasticidin-S, chinomethionat, difenzoquat-methylsulphate, oxolinic acid, mancozeb, maneb, methasulphocarb, metiram, ferbam, propineb, thiram, zineb, ziram, diethofencarb, iprovalicarb, benthiavalicarb, propamocarb hydrochloride, guanidine, dodine, kasugamycin, validamycin A, binapacryl, dinobuton, dithianon, isoprothiolane, fosetyl-aluminum, pyrazophos, tolclofos-methyl, dichlofluanid, flusulfamide, hexachlorobenzene, phthalide, pencycuron, quintozene, thiophanate-methyl, tolylfluanid, cyflufenamid, cymoxanil, ethirimol, furalaxyl, metrafenone, iminoctadine-triacetate, iminoctadine-tris(albesilate), kasugamycin hydrochloride-hydrate, dichlorophen, pentachlorophenol and its salts, dicloran, nitrothal-isopropyl, tecnazen, biphenyl, bronopol, diphenylamine, mildiomycin, oxine-copper and prohexadione calcium.

The hydrated aluminum-magnesium silicate is preferably selected from montmorillonite and attapulgite. The phosphate ester dispersant is preferably selected from a nonyl phenol phosphate ester and a tridecyl alcohol ethoxylated phosphate potassium salt.

The dispersant or dispersants are preferably present in a total concentration of from about 0.02% by weight to about 15% by weight based upon the total weight of all components in the composition.

Optionally, the composition further includes at least one of the additives selected from anti-freeze agents, anti-foam agents and biocides. These formulation components are well-known in the agrochemical arts. In one embodiment, the anti-freeze agent is a polyalkylene glycol, preferably propylene glycol, and when present, is present in an amount from about 5% to about 9% by weight of the total of all components in the composition. In an embodiment, the anti-foam agent is an alkylcyclotetrasiloxane, preferably an octamethylcyclotetrasiloxane silicone emulsion, for example, DOWCORNING® AF Emulsion or DOWCORNING® ANTIFOAM C Emulsion (Dow Corning Corporation). When present, the anti-foam agent is present in an amount of from about 0.001% to about 1% by weight of all the components in the total formulation. In another embodiment, the preservative is an isothiazolone or a mixture of isothiazolones, for example, KATHON® CG/ICP preservative or LEGEND® MK preservative (Rohm and Haas Corporation) or PROXEL™ BR preservative (Avecia Corporation). When present, the preservative is present in an amount of from about 0.001% to about 1% by weight of the total of all components in the formulation.

In one embodiment, the encapsulated crop protection agent is an encapsulated insecticide, present in an insecticidally effective amount. Preferred encapsulated insecticides are selected from the group consisting of abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin. In one embodiment, both the unencapsulated and the encapsulated pyrethroids are the same; in another embodiment both the unencapsulated and the encapsulated pyrethroids are bifenthrin.

Encapsulation of the crop protection agent is possible by methods known to one skilled in the agrochemical arts. In one embodiment, encapsulation comprises interfacial polymerization in the presence of the crop protection agent; in one preferred embodiment, the crop protection agent is an insecticide. The interfacial polymerization process can be accomplished at least in the following manner. An aqueous suspension of microcapsules containing the selected crop protection agent dissolved in a solvent is provided. The walls of the microcapsules are made of a porous polymer, such as polyurea. The microcapsule preparation comprises initially providing an aqueous solution containing an emulsifier, selected preferably from the group of the salts of ligninsulfonic acid, for example, the sodium, potassium, magnesium, and calcium, salts. Particularly effective is the sodium salt of ligninsulfonic acid. A solution of the crop protection agent and polyfunctional polyisocyanate is added to the composition of water and lignosulfonate surfactant. The solvent in which the crop protection agent is dissolved is a water-immiscible high boiling inert organic solvent having a boiling point, preferably, above 170° C. The resulting mixture is stirred sufficiently under suitable conditions to form a homogenous dispersion of small droplets of the crop protection agent within the aqueous phase. Thereafter, a polyfunctional amine is added with the stirring being continued until the polyfunctional amine has essentially fully reacted with the polyfunctional isocyanate. The polyfunctional isocyanate and the polyfunctional amine react in the presence of the surfactant under proper agitation and reaction conditions to form microcapsules having polyurea walls encapsulating the herbicide. The rate of the polymerization will depend on the reaction conditions employed. The rate of polymerization will generally be directly related to the temperature at which the reaction takes place. Further details can be found in U.S. Pat. No. 5,583,090, the entire disclosure of which is incorporated herein by reference.

Another embodiment is a composition that include unencapsulated bifenthrin, an encapsulated crop protection agent, a hydrated aluminum-magnesium silicate, at least one dispersant selected from the group consisting of a sucrose ester, a lignosulfonate, an alkylpolyglycoside, a naphthalenesulfonic acid formaldehyde condensate and a phosphate ester and an aqueous-based liquid fertilizer. The liquid fertilizer is preferably present in a concentration of from about 95.00% by weight to about 99.99% by weight based upon the total weight of all components in the formulation. The composition can further include at least one of an anti-freeze agent, an anti-foam agent and a biocide. Preferably the encapsulated crop protection agent is an encapsulated insecticide selected from the group consisting of abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin.

An especially preferred embodiment is an insecticidal composition that includes from about 15% to about 25% of unencapsulated bifenthrin, about 15% to about 25% of an encapsulated crop protection agent, from about 1% to about 20% of hydrated aluminum-magnesium silicate and from about 0.02% to about 15% of at least one dispersant selected from a sucrose ester, a lignosulfonate, an alkylpolyglycoside, a naphthalenesulfonic acid formaldehyde condensate and a phosphate ester, wherein all % are % by weight based upon the total weight of all components in the composition. Preferably the encapsulated crop protection agent is an encapsulated insecticide selected from the group consisting of abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin.

Another especially preferred embodiment is an insecticidal fertilizer composition that includes from about 0.75% to about 1.25% of unencapsulated bifenthrin, about 0.75% to about 1.25% of an encapsulated crop protection agent, from about 0.05% to about 1.0% of hydrated aluminum-magnesium silicate, from about 0.1% to about 0.75% of at least one dispersant selected from a sucrose ester, a lignosulfonate, an alkylpolyglycoside, a naphthalenesulfonic acid formaldehyde condensate and a phosphate ester, and from about 95% to about 99.99% of a liquid fertilizer, wherein all % are % by weight based upon the total weight of all components in the composition. Preferably, the encapsulated crop protection agent is an encapsulated insecticide selected from the group consisting of abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin.

The present disclosure also encompasses a method of controlling unwanted insects and providing nutrients to plants, wherein the method includes applying to an area infested with such insects and containing such plants an effective amount of a liquid fertilizer in combination with one of the compositions of this invention.

The present invention further encompasses a process for preparing a composition according to the present disclosure by dispersing bifenthrin in a mixture of water and at least one dispersant, and optionally an anti-freeze agent, an anti-foam agent and/or a biocide; wet milling the mixture to a particle size of about 0.1 to about 10 microns, preferably about 1 to about 5 microns in size, and adding a hydrated aluminum-magnesium silicate; followed by addition of an encapsulated crop protection agent. The process can further include the step of adding the resultant mixture to a liquid fertilizer. Preferably the encapsulated crop protection agent is an encapsulated insecticide selected from the group consisting of abamectin, aldicarb, bendiacarb, carbaryl, carbofuran, chlorpyrifos, methomyl, oxamyl, propoxur, thiodicarb, fenoxycarb, acephate, azinphos-methyl, phosmet, terbufos, endosulfan, fipronil, spinosad, milbemectin, fenoxycarb, pyriproxyfen, pymetrozine, clofentezine, etoxazole, chlorfenapyr, cartap hydrochloride, diflubenzuron, clorfluazuron, hexaflumuron, novaluron, teflubenzuron,buprofezin, cyromazine, methoxyfenozide, chromafenozide, amitraz, indoxacarb, azadirachtin and pyridaben, acrinathin, bifenthrin, cupermethrin, alpha-cypermethrin, beta-cypermethrin, zeta-cypermethrin, deltamethrin and tralomethrin.

The compositions of the present invention are further illustrated by the following examples. These examples serve only to illustrate the invention and should not be interpreted as limiting the scope of the invention in any way, since further modifications encompassed by the disclosed invention will be apparent to those skilled in the art. All such modifications are deemed to be within the scope of the invention as defined in the present specification and claims.

### EXAMPLES

### Example 1

### Bifenthrin and Encapsulated Chlorpyrifos Liquid Fertilizer Ready Formulation (Composition A)

### Step A. Encapsulated Chlorpyrifos Composition

A mixture of 376.75 grams of de-ionized water and 10.01 grams of lignosulfonate sodium salt (REAX® 88B available from MeadWestcaco) was added to a stainless steel beaker and the mixture was stirred and heated to 55° C. (aqueous phase).

In a separate stainless steel beaker a mixture of 187.5 grams of chlopyrifos (96.0% purity), 74.98 grams of aromatic 200 ND and 9.99 grams of methylene diphenyl diisocyanate was blended while maintaining a temperature of at least 55° C. (water-immiscible phase).

The 55° C. aqueous phase was transferred to a Waring blender equipped with a stainless steel pitcher and, while blending on a high setting, the water-immiscible phase was added. The resultant mixture was blended on a high setting for about 15 seconds then the mixing speed lowered to medium. Hexamethylene diamine (10.0 grams) was added to the mixture and stirring was continued for 2 minutes. The mixture was transferred to a heated glass reactor and stirred for 2 hours, maintaining a temperature of 50 to 55° C., to cure the microcapsules. The cured capsule mixture was transferred to a stainless steel adjustment tank and cooled to 30° C. With stirring,100.03 grams of attapulgite suspension aid (ATTAFLOW® FL from BASF), 70.10 grams of a phosphate ester surfactant (DEXTROL™ from Ashland Chemicals), 80.01 grams of an alkyl polyglucoside (AGNIQUE® PG 9116 from BASF) and 80.02 grams of propylene glycol were added to the microcapsule mixture maintaining a temperature of 40° C. or less. The pH of the mixture was adjusted by the addition of 0.8 gram of glacial acetic acid. Stirring was continued until a uniform mixture was obtained.

### Step B. Bifenthrin-Encapsulated Chlorpyrifos Liquid Fertilizer Ready Formulation

A mixture of 66.88 grams of encapsulated chlorpyrifos as prepared in Step A and 13.12 grams of CAPTURE® LFR (available from FMC Corporation) was stirred in a 200 mL beaker until homogenous. The physical stability of this mixture was tested by mixing the composition with an 11% nitrogen-37% phosphorous-0% potassium liquid fertilizer (aqueous) at a 5% to 95% weight ratio and observing the mixture's physical stability in a 500 milliliter/50 cm chromatography column. The stability of the test composition was compared with that of a traditional bifenthrin composition known in the art, TALSTAR® 2EC (available from FMC Corporation) that was mixed at a 5% to 95% ratio by weight with an 11-37-0 aqueous liquid fertilizer. To a glass cylinder were added 95 grams of an 11-37-0 aqueous liquid fertilizer and 5 grams of the Example composition or TALSTAR® 2EC. The glass cylinder was sealed and inverted 30 times to mix the components. The test mixture was poured into a glass chromatography column and a ten ml sample was withdrawn at ten minute intervals for one hour. The samples were analyzed by HPLC to determine the amount of bifenthrin in each sample in parts per million. Table 1 contains the results of the stability test.

TABLE 1
Physical Stability of Compositions Containing Bifenthrin
in High Phosphate Aqueous Liquid Fertilizer.

| | Concentration of Bifenthrin (ppm) In Samples Taken | | | | | | |
|---|---|---|---|---|---|---|---|
| Test | At The Elapsed Time (minutes) | | | | | | |
| Composition | 0 | 10 | 20 | 30 | 40 | 50 | 60 |
| Example 1 | 808 | 884 | 871 | 865 | 803 | 837 | 838 |
| TALSTAR ® | 9427 | 7557 | 7052 | 5630 | 4270 | 2984 | 2757 |
| 2EC | | | | | | | |

The test data above indicates that the composition of Example 1 is homogenous throughout the test, indicating good physical stability, whereas TALSTAR® 2EC is not homogenous and has poor physical stability when mixed with high phosphorus aqueous-based liquid fertilizer.

### Example 2

### Bifenthrin and Encapsulated Zeta-Cypermethrin Liquid Fertilizer Ready Formulation (Composition B)

### Step A. Encapsulated Zeta-Cypermethrin Composition

A mixture of 411.95 grams of de-ionized water and 7.52 grams of lignosulfonate sodium salt (REAX® 88B) was added to a stainless steel beaker and the mixture was stirred and heated to 40° C. (aqueous phase).

In a separate stainless steel beaker a mixture of 105.01 grams of zeta-cypermethrin (36.4% purity), 210.04 grams of aromatic 200 ND and 7.63 grams of methylene diphenyl diisocyanate was blended while maintaining a temperature of at least 40° C. (water-immiscible phase).

The 55° C. aqueous phase was transferred to a Waring blender equipped with a stainless steel pitcher and, while blending on a high setting, the water-immiscible phase was added. The resultant mixture was blended on a high setting for about 15 seconds then the mixing speed lowered to medium. Hexamethylene diamine (7.53 grams) was added to the mixture and stirring was continued for 2 minutes. The mixture was transferred to a heated glass reactor and stirred for 4 hours, maintaining a temperature of 50 to 55° C., to cure the microcapsules. The cured capsule mixture was transferred to a stainless steel adjustment tank and cooled to 30° C. The pH of the mixture was adjusted by the addition of 0.8 gram of glacial acetic acid. Stirring was continued until a uniform mixture was obtained.

### Step B. Bifenthrin-Encapsulated Zeta-Cypermethrin Liquid Fertilizer Ready Formulation

A mixture of 53.0 grams of encapsulated zeta-cypermethrin as prepared in Step A and 47.0 grams of CAPTURE® LFR (available from FMC Corporation) was stirred in a 200 mL beaker until homogenous. To this mixture was added 4.4 grams of an alkyl polyglycloside surfactant (AGNIQUE® PG 9116 from Cognis Corporation), 3.3 grams of a phosphate ester surfactant (DEXTROL® OC-180 from Ashland Chemicals) and 3.3 grams of attapulgite suspension aid (ATTAFLOW® FL from BASF). The physical stability of this mixture was tested by mixing the composition with an 11% nitrogen-37% phosphorous-0% potassium liquid fertilizer (aqueous) at a 5% to 95% weight ratio and observing the mixture's physical stability in a 500 milliliter/50 cm chromatography column. The stability of the test composition was compared with that of a traditional bifenthrin composition in the art, TALSTAR® 2EC (available from FMC Corporation) that was mixed at a 5% to 95% by weight with an 11-37-0 aqueous liquid fertilizer. To a glass cylinder were added 95 grams of an 11-37-0 aqueous liquid fertilizer and 5 grams of the Example composition or TALSTAR® 2EC. The glass cylinder was sealed and inverted 30 times to mix the components. The test mixture was poured into a glass chromatography column and a ten ml sample was withdrawn at ten minute intervals for one hour. The samples were analyzed by HPLC to determine the amount of bifenthrin in each sample in parts per million. Table 2 contains the results of the stability test.

TABLE 2
Physical Stability of Compositions Containing Bifenthrin
In High Phosphate Aqueous Liquid Fertilizer.

| | Concentration of Bifenthrin (ppm) In Samples Taken | | | | | | |
|---|---|---|---|---|---|---|---|
| Test | At The Elapsed Time (minutes) | | | | | | |
| Composition | 0 | 10 | 20 | 30 | 40 | 50 | 60 |
| Example 2 | 2558 | 2506 | 2396 | 2143 | 1886 | 1726 | 1706 |
| TALSTAR ® | 9427 | 7557 | 7052 | 5630 | 4270 | 2984 | 2757 |
| 2EC | | | | | | | |

The test data above indicates that the composition of Example 2 is homogenous throughout the test, indicating good physical stability, whereas TALSTAR® 2EC is not homogenous and has poor physical stability when mixed with high phosphorus aqueous liquid fertilizer.

### Example 3

### Encapsulated Zeta-Cypermethrin Composition

A mixture of 392.87 grams of de-ionized water and 7.75 grams of lignosulfonate sodium salt (Reax® 88B) was added to a stainless steel beaker and the mixture was stirred and heated to 40° C. (aqueous phase). In a separate stainless steel beaker a mixture of 185.04 grams of zeta-cypermethrin (36.4% purity), 152.54 grams of aromatic 200 ND and 7.57 grams of methylene diphenyl diisocyanate was blended while maintaining a temperature of at least 40° C. (water-immiscible phase).

The 55° C. aqueous phase was transferred to a Waring blender equipped with a stainless steel pitcher and, while blending on a high setting, the water-immiscible phase was added. The resultant mixture was blended on a high setting for about 15 seconds then the mixing speed lowered to medium. Hexamethylene diamine (7.75 grams) was added to the mixture and stirring was continued for 2 minutes. The mixture was transferred to a heated glass reactor and stirred for 8 hours, maintaining a temperature of 50 to 55° C., to cure the microcapsules. The cured capsule mixture was transferred to a stainless steel adjustment tank and cooled to 30° C. The pH of the mixture was adjusted by the addition of 0.7 gram of glacial acetic acid. Stirring was continued until a uniform mixture was obtained.

While this invention has been described with an emphasis upon preferred embodiments, it will be obvious to those of ordinary skill in the art that variations in the preferred compositions and methods can be used and that it is intended that the invention can be practiced otherwise than as specifically described herein. Accordingly, this invention includes all modifications encompassed within the spirit and scope of the invention as defined by the claims that follow.

1. An insecticidal composition comprising:
a) unencapsulated bifenthrin;
b) at least one encapsulated crop protection agent, wherein said crop protecting agent has a melting point of 50° C. or less;
c) a hydrated aluminum-magnesium silicate; and
d) at least one dispersant selected from the group consisting of a sucrose ester, a lignosulfonate, an alkylpolyglycoside, a naphthalenesulfonic acid formaldehyde condensate and a phosphate ester.

2. An insecticidal composition comprising:
a) from about 15% to about 25% of unencapsulated bifenthrin;
b) from about 15% to about 25% of at least one encapsulated crop protection agent, wherein said crop portecting agent has a melting point of 50° C. or less;
c) from about 1% to about 20% of hydrated aluminum-magnesium silicate; and
d) from about 0.2% to about 20% of at least one dispersant selected from the group consisting of a sucrose ester, a lignosulfonate, an alkylpolyglycoside, a naphthalenesulfonic acid formaldehyde condensate and a phosphate ester;
wherein all % are % by weight based upon the total weight of all components in the composition.

3-4. (canceled)

5. The composition of claim 1, wherein said encapsulated crop protection agent is an insecticide selected from the group consisting of chlorpyrifos, and cypermethrin, zeta-cypermethrin, tefluthrin.

6. The composition of claim 1, wherein said encapsulated crop protection agent is a fungicide selected from the group consisting of cyproconazole, difenoconazole, diniconazole, propiconazole, tetraconazole, triflumizole, fuberidazole, metalaxyl, aldimorph, fenpropimorph,

7. The composition of claim 1, wherein encapsulation comprises interfacial polymerization in the presence of the crop protection agent.

8. The composition of claim 1, wherein said encapsulated crop protection agent is zeta-cypermethrin.

9. The composition of claim 1, wherein said encapsulated crop protection agent is chlorpyrifos.

10. The composition of claim 1, wherein the hydrated aluminum-magnesium silicate is selected from the group consisting of montmorillonite and attapulgite.

11. The composition of claim 1, wherein the phosphate ester is selected from the group consisting of a nonyl phenol phosphate ester and a tridecyl alcohol ethoxylated phosphate potassium salt.

12. The composition of claim 1 further comprising a liquid fertilizer.

13. The composition of claim 12, wherein said liquid fertilizer is aqueous-based.

14. The composition of claim 13, wherein said liquid fertilizer is present in a concentration of about 95.0% by weight to about 99.99% by weight based on the total weight of all components in the composition.

15. The composition of claim 14, wherein unencapsulated bifenthrin is present in about 0.75% to about 1.25%, the encapsulated crop protection agent is present in about 0.75% to about 1.25%, the hydrated aluminum-magnesium silicate is present in about 0.05% to about 1.0%, and the dispersant is present in about 0.1% to about 0.75% by weight based on the total weight of all components in the composition.

16. The composition of claim 1, further comprising at least one additive selected from the group consisting of anti-freeze agents, anti-foam agents and biocides.

17. The composition of claim 2, further comprising at least one additive selected from the group consisting of anti-freeze agents, anti-foam agents and biocides.

18. The composition of claim 15, further comprising at least one additive selected from the group consisting of anti-freeze agents, anti-foam agents and biocides.
